(19) United States
(12) Patent Application Publication
(10) Pub. No.: US 2021/0016685 A1
(43) Pub. Date: Jan. 21, 2021

(54) VEHICLE SEAT MOUNTING ARRANGEMENT

(71) Applicant: Pressan Madeni Esya San. Tic. A.S., Istanbul (TR)

(72) Inventors: Buelent Bilgincan, Istanbul (TR); Izzet Durugoenuel, Istanbul (TR)

(21) Appl. No.: 16/980,224

(22) PCT Filed: Mar. 13, 2018
(86) PCT No.: PCT/EP2018/056272

§ 371 Date: Sep. 11, 2020

(51) Int. Cl. B60N 2/015; B60N 2/08

(52) U.S. Cl. CPC B60N 2/01541; B60N 2/0818

(57) ABSTRACT

The invention relates to a vehicle seat mounting arrangement, comprising a profile rail (3) and at least one mounting device (6), wherein the mounting device (6) comprises a lock mechanism (10) with two bracket elements (11) to be inserted into the profile rail (3) and a locking element (12), which bracket elements (11) may be spread apart from each other into a spreaded state to create a form fit engagement with the profile rail (3), wherein the lock mechanism (10) may be brought into a locked state by driving the locking element (12) into at least one locking position between the bracket elements (11), securing the spreaded state and thereby the form fit engagement with the profile rail (3), and into an unlocked state by driving the locking element (12) out of the locking position, allowing release of the spreaded state and thereby out of the form fit engagement with the profile rail (3), wherein during inserting the bracket elements (11) an engagement with the profile rail (3) forces the bracket elements (11) at least partly to be spread apart from each other.

The invention relates to a vehicle seat mounting arrangement according to claim 1, a riser arrangement according to claim 11 and a vehicle seat arrangement according to claim 15.

In the state of the art several different seats with mounting devices for mounting a vehicle seat to a profile rail are known.

In one design variant, the mounting devices are directly mounted to the profile rail, whereas in other design variants a slide is mounted to the profile rail. The extension of the slide along the profile rail is usually almost the same as the extension of the seat. Said slide is usually arranged in or on the profile rail and provides a locking of the seat along the longitudinal extension of the profile rail.

It is known that the seat is mounted via two latching mechanisms to the slide each comprising a latch and a pawl. In this case, the seat is mounted to the slide and demounted from the slide while the slide remains in the profile rail. This leads to a heavy and complex construction and brings some disadvantages while mounting the seat because the slides of the profile rails have to be aligned to each other prior mounting and the latching mechanisms need to be accurately positioned relatively to the slides while mounting.

In another known embodiment the seat is directly mounted to a slide and the slide may be mounted and demounted from the profile rail. In such case a pivoting of the seat is not possible, for what reason the seat is more difficult to handle while mounting.

One of said slides is known to comprise two bracket elements which are spreadable and may be locked with the profile rail by a locking element moved between them and thereby spreading them apart and securing the spreaded bracket elements in their spreaded state.

However prior described constructions do have different disadvantages. They have a complex design and are comparatively heavy, leading to a less comfortable mounting and demounting of the seat for the user.

It is therefore an object of the invention to facilitate the mounting and demounting of vehicle seats to the profile rail of a vehicle.

The problem to be solved is therefore to improve the handling of the seats known in the art while mounting and demounting them.

This problem is solved by a vehicle seat mounting arrangement according to claim 1.

In detail, a vehicle seat mounting arrangement is provided, comprising a profile rail and at least one mounting device, wherein the mounting device comprises a lock mechanism with two bracket elements to be inserted into the profile rail and a locking element, which bracket elements may be spread apart from each other into a spreaded state to create a form fit engagement of a profile rail, wherein the lock mechanism may be brought into a locked state by driving the locking element into at least one locking position between the bracket elements, securing the spreaded state and thereby the form fit engagement with the profile rail, and into an unlocked state by driving the locking element out of the locking position, allowing release of a spreaded state and thereby out of a form fit engagement of the profile rail. Thereby the mounting and demounting of a seat can be facilitated. This simple locking mechanism has not only a light weight and is easy to manufacture, it also is applicable to the profile rail in an easy manner.

The usage is further facilitated when during inserting the bracket elements an engagement with a profile rail forces the bracket elements at least partly to be spread apart from each other. Thereby the bracket elements can be spread apart at least partly for example by the weight force of a seat assembled on the mounting device. This facilitates the locking operation by driving the locking element into the at least one locking position between the bracket elements, because no additional force is needed for spreading the bracket elements apart. Thus the locking can be carried out with lower actuation force.

Claims 2 to 5 describe preferred embodiments of the bracket elements and their interaction with the profile rail allowing a simple construction, low actuation forces for driving the locking element as well as a further facilitation of the handling for the user.

Claims 6 and 7 describe preferred embodiments of the profile rail and its interaction with the lock mechanism.

According to claim 8 the mounting device may be lockable along the longitudinal extension of a profile rail.

In claim 9 the at least one locking position respectively the locking positions are further described, while in claim 10 the movement of the locking element is further described.

The above indicated problem is further solved by a riser arrangement according to claim 11.

In detail, a riser arrangement for a vehicle seat is provided, comprising a profile rail and a riser, the riser comprising a front mounting device and a rear mounting device, both lockable to the profile rail, wherein the front mounting device and the rear mounting device can interact independently of each other with the profile rail. Thereby the mounting and demounting of the vehicle seat is facilitated for a user. He can better unlock respectively demount the seat with its mounting devices sequentially and thereby preferably pivot the seat allowing a better handling.

The front mounting device and/or the rear mounting device of the riser comprises a lock mechanism with two bracket elements to be inserted into the profile rail and a locking element, which bracket elements may be spread apart from each other into a spreaded state to create a form fit engagement with the profile rail, when the lock mechanism may be brought into locked state by driving the locking element into at least one locking position between the bracket elements, securing the spreaded state and thereby the form fit engagement with the profile rail, and into an unlocked state by driving the locking element out of a locking position allowing release of a spreaded state and thereby out of a form fit engagement with the profile rail. This allows a very easy and handy mounting of the mounting devices by simply inserting the brackets and moving the locking element into a locking position.

Here and preferably the front mounting device and/or the rear mounting device is of the nature described in connection with the vehicle seat mounting arrangement.

It may comprise the features of the vehicle seat mounting arrangement described separately or in any combination.

The possibility of the mounting devices to interact independently of each other with the profile rail is further defined in the preferred embodiment according to claim 12.

A preferred embodiment relating to the pivoting of an underseat structure is described in claim 13, which further facilitates the mounting and demounting of a seat by enabling to pivot the seat while mounting and demounting the front and rear mounting device independently from each other.

Preferred configurations of the lockability of the front and rear mounting device are described in claim 14.

The above named problem is also solved by a vehicle seat arrangement according to claim 15.

The same advantages are reached as described in connection with the vehicle seat mounting arrangement and/or the riser arrangement. The vehicle seat mounting arrangement of the vehicle seat arrangement as well as the riser arrangement of the vehicle seat arrangement may be configured as described in connection with the vehicle seat mounting arrangement and/or the riser arrangement.

In claims 16 and 17 preferred ways of actuation of the mounting devices via actuation levers are described. They facilitate the user experience while mounting and demounting the vehicle seat from the profile rail.

A preferred embodiment of the invention shall be described with its benefits in connection with the drawings in which

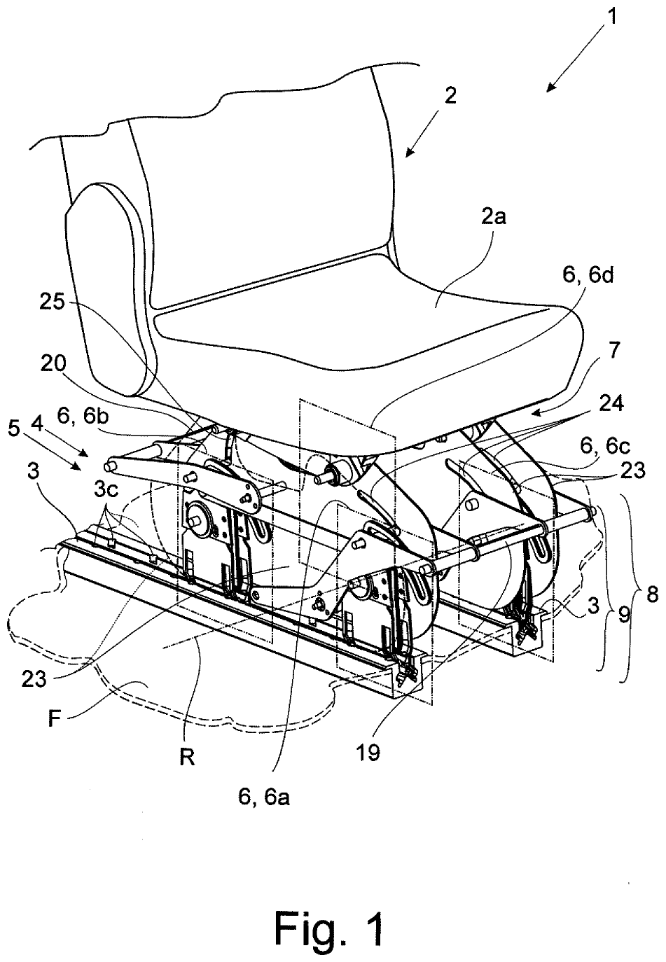

FIG. 1 schematically shows a vehicle seat arrangement according to the invention,

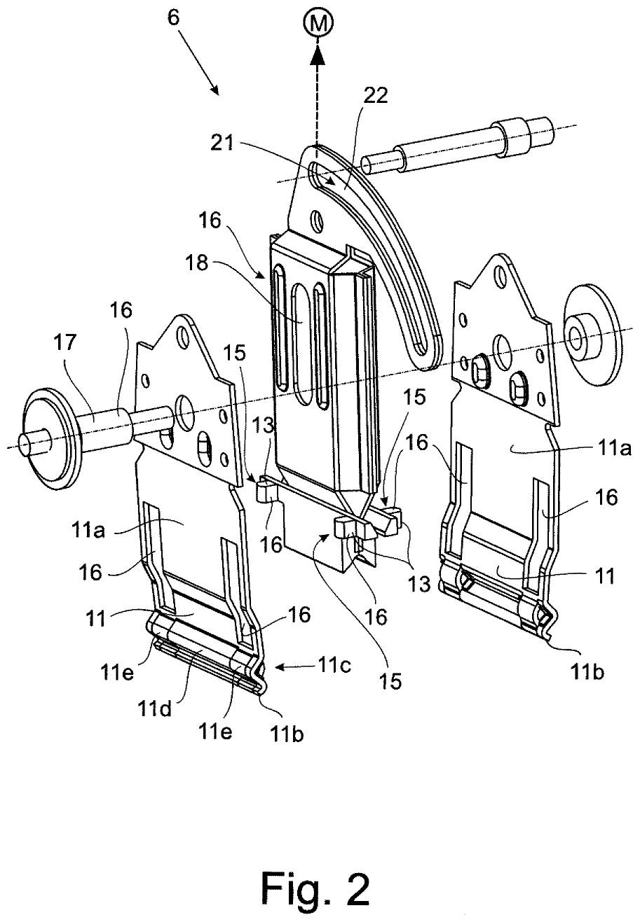

FIG. 2 schematically a mounting device of the vehicle seat arrangement in an exploded assembly view,

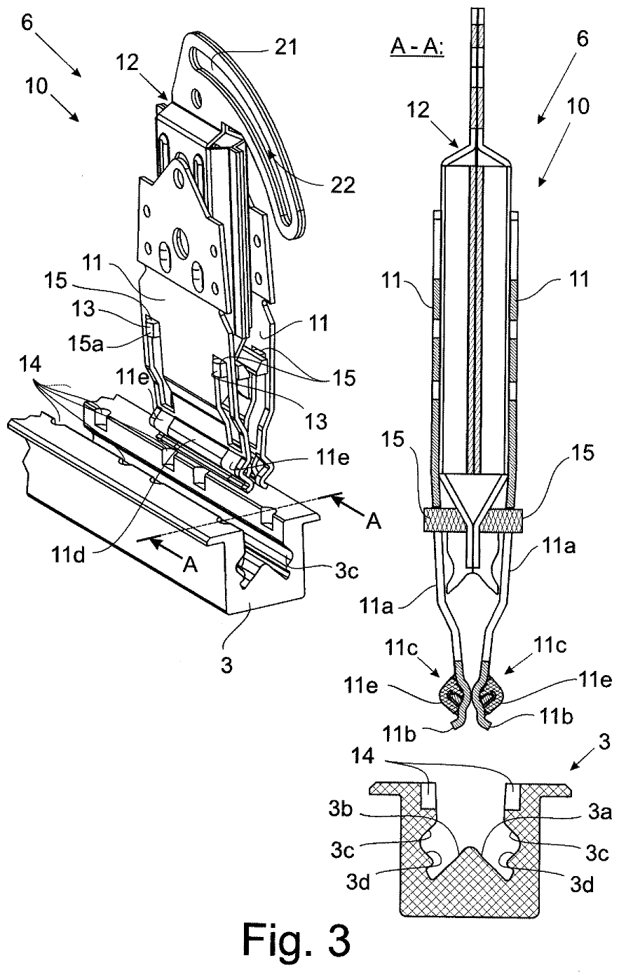

FIG. 3 shows the mounting device of FIG. 2 unmounted from the profile rail, thus being separated from the profile rail, and with the lock mechanism in an unlocked state, the locking element being in an unlocking position,

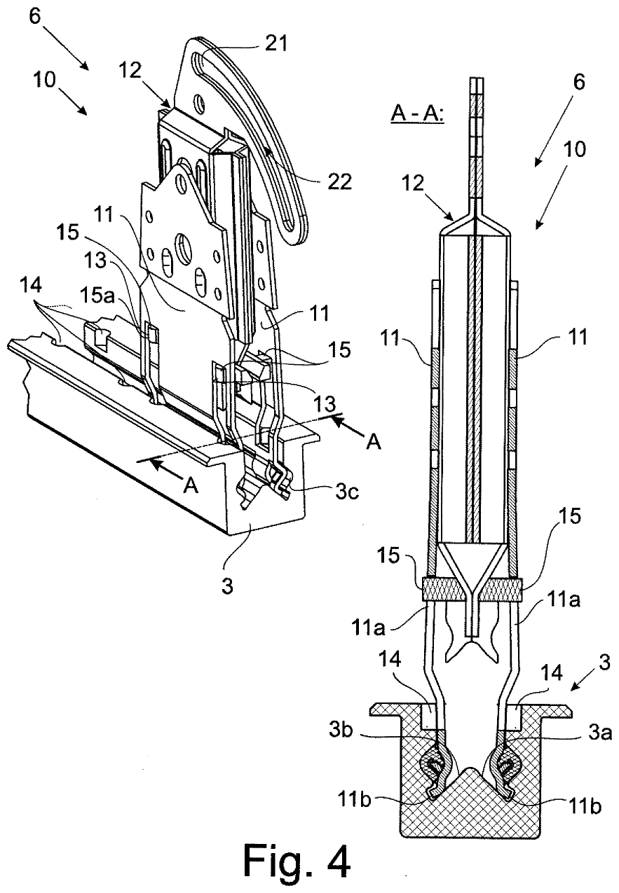

FIG. 4 shows the mounting device of FIG. 2 inserted into the profile rail with the lock mechanism in an unlocked state, the locking element being in an unlocking position,

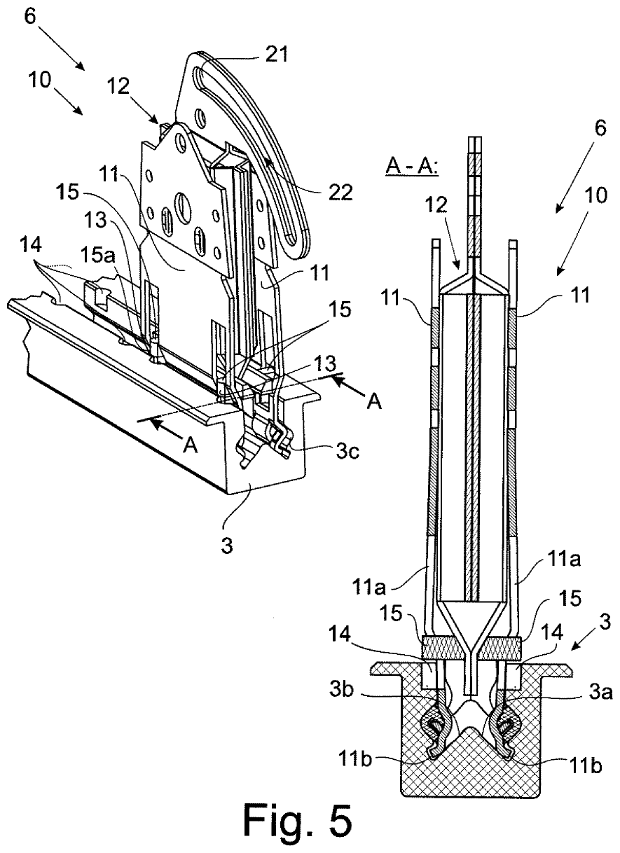

FIG. 5 shows the mounting device of FIG. 2 being mounted to the profile rail with the lock mechanism in a locked state, the locking element being in a first locking position, locking a movement of the mounting device out of the profile rail, but allowing a movement along the longitudinal extension of the profile rail,

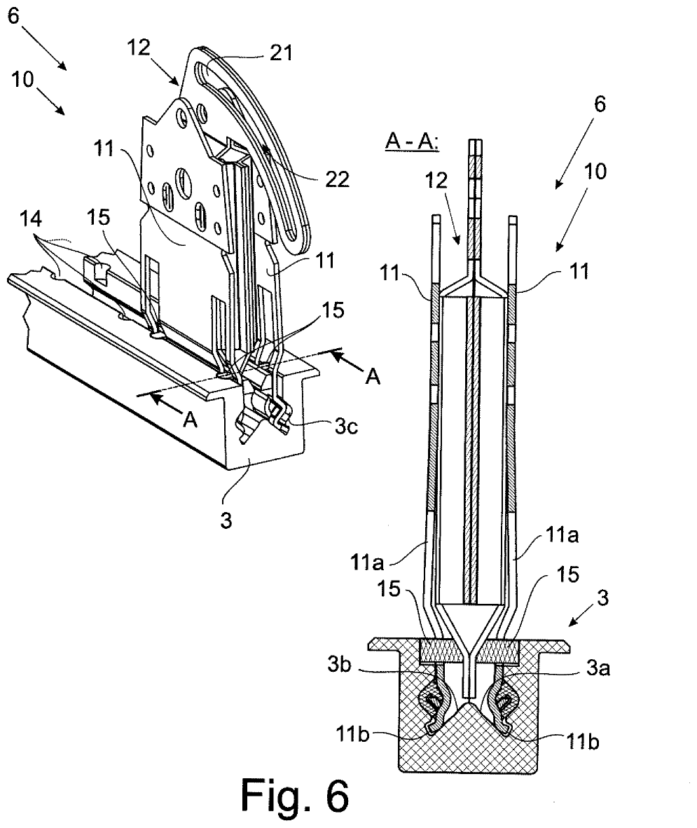

FIG. 6 shows the mounting device of FIG. 2 being mounted to the profile rail with the lock mechanism in a locked state, the locking element being in a second locking position, locking a (release) movement of the mounting device out of the profile rail and locking a movement along the longitudinal extension of the profile rail.

FIG. 1 shows a vehicle seat arrangement 1 comprising a vehicle seat 2 and at least one profile rail 3.

The seat arrangement 1 may be used in different types of vehicles. Preferably it is used in wheeled vehicles like commercial vehicles, busses, trucks, vans, SUVs and/or cars or the like. Alternatively the seat arrangement may also be used on ships or in airplanes.

As can be seen in FIG. 1, the vehicle seat 2 comprises a vehicle seat mounting 4 and a padding 2a. The vehicle seat 2 may further comprise a backrest. The vehicle seat mounting 4 and the profile rail 3 form a vehicle seat mounting arrangement 5 according to the invention.

In FIG. 1 the vehicle seat mounting arrangement 5 comprises at least one mounting device 6, which shall be described in detail in connection with FIGS. 2 to 6. The vehicle seat mounting arrangement 5 may comprise two, three, four or even more mounting devices 6. In the embodiment of FIG. 1 the vehicle seat mounting arrangement 5 comprises four mounting devices 6. Two of them, a front mounting device 6a and a rear mounting device 6b, are mounted on one profile rail 3. The other two, also a front mounting device 6c and a rear mounting device 6d, are mounted on another profile rail 3.

The vehicle seat mounting arrangement 5 may further comprise an underseat structure 7 to which the mounting devices 6 of the vehicle seat mounting arrangement 5 may be fastened.

In the embodiment of FIG. 1 the vehicle seat 2 respectively the seat mounting structure 7 comprises a riser 9 according to the invention, which itself then comprises the mounting devices 6.

A riser arrangement 8 of the invention comprises a riser 9 and a profile rail 3. The riser 9 comprises at least one front mounting device 6a and at least one rear mounting device 6b. In the embodiment of FIG. 1 the riser 9 comprises a first front mounting device 6a and a first rear mounting device 6b to be mounted to a first profile rail 3 and a second front mounting device 6c and a second rear mounting device 6d to be mounted to a second profile rail 3.

However, the vehicle seat mounting arrangement 5 may also comprise only one or more mounting devices 6 without comprising the riser 9.

FIG. 2 shows one mounting device 6 of the embodiment of FIG. 1 in an exploded assembly view. The mounting device 6 comprises a lock mechanism 10 with two bracket elements 11 and a locking element 12.

The profile rail 3 has a profile cut out into which bracket elements 11 may be inserted for mounting and locking of the mounting device 6 to the profile rail 3. Here and preferably the opening of the profile cut out for introducing the bracket elements 11 is less than 30 mm, preferably less than 25 mm, more preferably 22 mm or less.

Thus the bracket elements 11 may be inserted into the profile rail 3 while mounting the mounting device 6 to the profile rail 3. They may be spread apart from each other into a spreaded state in which they may create a form fit engagement with the profile rail 3 (FIGS. 3 and 4).

The lock mechanism 10 is configured such that it can be brought into a locked state by driving the locking element 12 into at least one locking position between the bracket elements 11. This is shown in FIGS. 5 and 6. The locking element 12 secures in the locking position the spreaded state of the bracket elements 11 and thereby secures the form fit engagement with the profile rail 3. The mounting device 6 is in this configuration locked to the profile rail 3.

The lock mechanism 10 may also be brought into an unlocked state by driving the locking element 12 out of a locking position. In FIGS. 3 and 4 the lock mechanism 10 is in an unlocked state. The locking element 12 is driven in an unlocking position. The locking element 12 allows the release of the spreaded state of the bracket elements 11 and thereby the release out of the form fit engagement with the profile rail 3 (FIGS. 3 and 4).

In the embodiment of the figures and preferably, the bracket elements 11 are preloaded towards each other. Alternatively, one bracket element 11 may be preloaded towards the other one. This allows the bracket elements 11 to leave the spreaded state automatically when the mounting device 6 is removed from the profile rail 3. Preferably both bracket elements 11 move after or while removal of the mounting device 6 from the profile rail 3 in an unspreaded state, in which they preferably touch each other, as shown in FIG. 3. In the embodiment of the figures the bracket elements 11 are preloaded towards each other by themselves, preferably their base bodies 11a. It is conceivable that the bracket elements 11 are additionally or alternatively preloaded towards each other by separate spring elements (not shown).

As can be seen in FIG. 2, here and preferably the bracket elements 11 each comprise a base body 11a. It is preferably made of metal, in particular made of formed sheet material. Especially preferred the bracket elements respectively the base bodies 11a of the bracket elements 11 are made of spring steel.

Alternatively the base body 11a of the bracket elements 11 may be made of one formed sheet material which has basically been brought into a U-shaped form with each arm of the U-shaped base body 11a being one bracket element 11.

Here the profile rail 3 and the mounting device 6 are configured such that during inserting the bracket elements 11 into the profile rail 3 an engagement with the profile rail 3 forces the bracket elements 11 at least partly to be spread apart from each other. In the embodiment of the figures the bracket elements 11 are spread apart into the spreaded state forming the form fit engagement with the profile rail 3.

The at least partly spreading of the bracket elements 11 has the advantage that the actuation forces for driving the locking element 12 into the locked state may be significantly reduced. This makes it a lot easier for a user and/or a spring and/or a motor M to move the locking element 12 into and/or out of a locking position. It further enables the use of springs to drive the locking element into a locking position or out of a locking position, especially into an unlocking position.

Here and preferably the at least partly spreading of the bracket elements 11 is achieved by a spreading contour 3a. Preferably the spreading contour 3a is essentially of triangular shape. A tip of the spreading contour 3a is preferably in the middle of a cross-section of the profile rail 3 perpendicular to its longitudinal axis. As can be seen in the combination of FIGS. 3 and 4 the profile rail 3 comprises a spreading contour 3a, in particular at the bottom 3b of the profile rail 3, which during inserting of a mounting device 6 into the profile rail 3 forces the bracket elements 11 at least partly to be spread apart from each other. Here they are spread apart from each other by the spreading contour 3a until they reach the form fit engagement with the profile rail 3 while mounting of the mounting device 6 to the profile rail 3. In order to facilitate the inserting and the spreading of the bracket elements 11 as well as the interaction with the spreading contour 3a, the tips 11b of the ends 11c of the bracket elements 11, which ends 11c are to be inserted into the profile rail 3, are oriented, especially formed, away from each other. This enables slipping of the tips 11b on the spreading contour 3a and/or centering of the bracket elements 11 while inserting into the profile rail 3.

As can be further seen from the FIGS. 2 to 6 the bracket elements 11, preferably the ends 11c of the bracket elements 11, comprise a locking contour 11d which is configured to establish the form fit engagement for locking a release movement of the mounting device 6 directed out of the profile rail 3 when the lock mechanism 10 is in a locked state. As can be seen from FIGS. 2 to 6 each bracket element 11 comprises a locking contour 11d which each is configured to establish the form fit engagement for locking a release movement of a mounting device 6 directed out of a profile rail 3 when the lock mechanism 10 is in a locked state. Alternatively it is conceivable that only one of the bracket elements 11 comprises a locking contour 11d for establishing the locking engagement.

Here and preferably the locking contour 11d, at least in part, is convexly curved away from the other bracket element 11. It may be provided at least partly by at least one formed section of the base body 11a.

Additionally or alternatively at least one of the bracket elements 11, in particular both bracket elements 11, comprise at least one guiding element 11e. It may be a part of the form fit engagement for locking a releasing movement directed out of the profile rail 3 when the lock mechanism 10 is in a locked state. In the embodiment of the figures the guiding element 11e respectively the guiding elements 11e are of plastic material. The guiding elements 11e improve the noise characteristics of the mounting and demounting of the mounting device 6 into the profile rail 3 as well as the sliding forward or backward of the mounting device 6 in the profile rail 3. The guiding elements 11e are preferably snapped to the bracket elements 11. This ensures easy manufacturability.

The locking contour 11d respectively locking contours 11d of the bracket element 11 respectively bracket elements 11 may interact with a locking contour 3c respectively locking contours 3c of the profile rail 3.

Here and preferably the profile rail 3 comprises two locking contours 3c, each of which at least in part corresponds to a locking contour 11d of the respective bracket element 11. Each locking contour 3c of the profile rail 3 and the assigned locking contour 11d of the respective bracket element 11 have a complementary shape to each other (FIGS. 4 to 6). The locking contour 3c of the profile rail 3 is here and preferably provided by a side wall 3d of the profile rail 3 respectively the locking contours 3c are provided each by one of the side walls 3d of the profile rail 3. The locking contours 3c are here provided by inner side walls of the profile rail 3. The locking contour 3c is here concavely curved, meaning away from the bracket elements 11.

The lock mechanism 10 also comprises an x-locking, that is a locking mechanism for locking the mounting device 6 against a movement along the longitudinal extension (x-direction) of the profile rail 3. Here and preferably the bracket elements 11 and/or the locking element 12 comprise an x-locking contour 13 which locks a movement of a mounting device 6 in the x-direction along the longitudinal extension of a profile rail 3. The profile rail 3 comprises corresponding x-locking contours 14. These are arranged along the longitudinal extension of the profile rail 3 and allow the locking of a movement in x-direction at several positions along the profile rail 3.

In the embodiment of the figures the x-locking contour 13 is provided by an x-locking element 15. It has a rounded tip 15a. Here the locking element 12 comprises the x-locking element 15. Alternatively the bracket elements 11 respectively one bracket element 11 may comprise the x-locking contour 13. In particular the x-locking contour 13 may be formed by the base body 12 of a bracket element 11 (not shown).

As can be seen in FIGS. 5 and 6 the locking element 11 secures at least in one locking position, preferably in the locking positions, the bracket elements 11 in a spreaded state, in which a demounting of a mounting device 6 from the profile rail 3 is prevented.

In FIG. 5 the locking element 12 is moved in a first locking position, in which it prevents a demounting of the mounting device 6 from the profile rail 3 and preferably allows a movement of the mounting device 6 along the longitudinal extension of the profile rail 3. Preferably the locking element 12 is inserted in-between the bracket elements 11 into the profile rail 3 in the first locking position.

In FIG. 6 the locking element 12 is movable in a second locking position, in which it prevents a demounting of the mounting device 6 from the profile rail 3 and a movement of the mounting device 6 along the longitudinal extension of the profile rail 3. From the first locking position to the second locking position the locking element 12 is driven further towards the profile rail 3. Here and preferably in the second locking position the locking element 12 is inserted deeper in-between the bracket elements 11 into the profile rail 3 then in the first locking position.

The profile rail 3 comprises notches which provide the x-locking contours 14. Here and preferably the notches are arranged on the top side of the profile rail 3.

As can be seen from FIGS. 2 to 6, the locking element 11 is here and preferably movable in between the bracket elements 11, in particular in between the base bodies 11a of the bracket elements 11 from the locking position respectively the locking positions to the unlocking position. In the embodiment of the figures the locking element 12 is transversally, in particular linearly, movable into and/or out of the locking position, preferably locking positions. Alternatively or additionally it may be movable rotationally into and/or out of the locking position, preferably locking positions. In the embodiment of the figures the locking element 12 is preloaded towards a locking position, in particular via a spring, preferably towards the second locking position such, that the locking element may be automatically moved into the locking position, especially the second locking position.

Additionally or alternatively a motor M may be used for driving the locking element 12 into and/or out of a locking position.

Here and preferably the movement of the locking element 12 is guided by a guiding arrangement 16. The guiding arrangement 16 may be provided by the locking element 12 and/or the bracket element(s) 11 and/or a bolt 17. In the embodiment of the figures the guiding arrangement 16 is provided by the bolt 17 and the oblong hole 18 of the locking element 12. The guiding arrangement 16 may additionally or alternatively be provided by the x-locking element 15 and the bracket elements 11.

The riser arrangement 8 according to the invention comprises a profile rail 3 and a riser 9.

The riser 9 comprises a front mounting device 6a and a rear mounting device 6b, both lockable to the profile rail 3. As can be seen in FIG. 1 the front mounting device 6a and the rear mounting device 6b are designed such that they can interact independently of each other with the profile rail 3. The independent interaction allows to facilitate the mounting and demounting of the vehicle seat 2 to the profile rail 3 by separate unlocking and/or demounting of the front mounting device 6a respectively rear mounting device 6b from the profile rail 3.

In case of a riser 9 the front mounting device 6a and/or the rear mounting device 6b comprises a lock mechanism 10 with two bracket elements 11 to be inserted into the profile rail 3 and a locking element 12, which bracket elements 11 may be spread apart from each other into a spreaded state to create a form fit engagement with the profile rail 3. The lock mechanism 10 may be brought into a locked state by driving the locking element 12 into at least one locking position between the bracket elements 11, securing the spreaded state and thereby the form fit engagement with the profile rail 3, and into an unlocked state by driving the locking element 12 out of a locking position, allowing release of the spreaded state and thereby out of the form fit engagement with the profile rail 3.

It is to be pointed out, that in this case the full benefits of the invention can be reached when the riser arrangement is designed without a slide on which the vehicle seat 2 is mounted. Here no slide is provided which connects the front and a rear mounting device 6a, 6b with the profile rail 3.

The expression that the front mounting device 6a and the rear mounting device 6b can interact independently of each other with the profile rail 3, here and preferably means, that the mounting devices 6 of the riser 9 can be unlocked from the profile rail 3 independently from each other and/or that the mounting devices 6 of the riser 9 can be demounted from the profile rail 3 independently from each other. Especially the latter improves the usability and the comfort for a user when demounting the vehicle seat 2. While demounting respectively after demounting the mounting device 6 remains with the vehicle seat 2.

The riser 9 and/or the vehicle seat mounting arrangement 5 may comprise an underseat structure 7 to which the mounting devices 6, especially the front mounting device 6a and the rear mounting device 6b, are mounted.

The riser 9 here and preferably allows a pivoting of the underseat structure 7 in relation to the profile rail 3 while one of a mounting devices 6, preferably the front mounting device 6a, is locked to the profile rail 3 and another one of the mounting devices 6, preferably the rear mounting device 6b, is demounted from the profile rail 3. This is here and preferably enabled by a pivot mechanism, preferably acting around a rotational axis R. The pivot mechanism is provided by the mounting device 6, here and preferably by the bolt 17 respectively bolts 17. The rotational axis R here and preferably intersects with one of the mounting devices 6, especially with the mounting device 6 being locked to the profile rail 3 while the seat 2 is being pivoted.

Here and preferably one or the mounting devices 6, preferably the front mounting device 6a, is lockable to the profile rail 3 such that it cannot be moved from the profile rail 3 and cannot be moved along the profile rail 3. Furthermore one of the mounting devices 6, preferably the rear mounting device 6b, is lockable to the profile rail 3 such that it cannot be moved from the profile rail 3, but is movable along the profile rail 3. In this case it is possible to provide the x-locking only in one of the mounting devices 6, here the front mounting device 6a, which thus allows to move the vehicle seat 2 forward and backward in the profile rail 3 by only unlocking the front or only unlocking the rear mounting device 6 respectively devices 6.

Alternatively it is conceivable that the front mounting device 6a as well as the rear mounting device 6b provide a locking against a demounting of the front mounting device 6a and the rear mounting device 6b as well as a locking against a movement along the longitudinal extension of the profile rail 3.

The vehicle seat 2 further comprises an actuation lever 19 with which at least one mounting device 6, in particular the front mounting device 6a or the front mounting devices 6a, is/are lockable and/or unlockable by actuation of the actuation lever 19 such that the mounting device 6 can be removed from the profile rail 3 and can be moved along the profile rail 3. The actuation lever 19 moves the locking elements 12 of the mounting device, here the front mounting device, for locking and unlocking via an actuation contour 21 of the locking elements 11. The actuation contour 21 is here provided via an oblong hole, especially a curved oblong hole 22 (FIGS. 1 and 2).

Here and preferably a second actuation lever 20 is provided. Thereby at least one mounting device 6, in particular the rear mounting device 6b or the rear mounting devices 6b, is/are lockable and/or unlockable by actuation of a second actuation lever 20 such that the mounting device 6 can be removed from the profile rail 3. It is conceivable, that a movement along the profile rail 3 is lockable and/or unlockable with the second actuation lever 20, but preferably, a movement along the profile rail 3 cannot be locked by actuation of the second actuation lever 20. The actuation lever 19 moves the locking elements 12 of the mounting device, here the rear mounting device, for locking and unlocking via an actuation contour 21 of the locking elements 11. The actuation contour 21 is here provided via the oblong hole, especially a curved oblong hole 22 (FIGS. 1 and 2).

Additionally it is conceivable, that the first actuation lever 19 can only be actuated in a position which allows the mounting device 6 actuated by the first actuation lever to be removed from the profile rail 3 after or simultaneously to an actuation of the second actuation 20 lever. This function is provided by at least one frame 23, in particular by an oblong hole 24, 25 of frame 23. The frame 23 limits the maximum deviation of the first actuation lever 19 until the second actuation lever 20 is actuated, here and preferably until the second actuation lever 20 is actuated and the seat is pivoted. In the embodiment of the figures it pivots around the axis R.

This frame 23 is here, in particular rigidly, connected to the vehicle seat 2. In the embodiment of the figures the first actuation lever 19 and/or the second actuation lever 20 is/are movable, in particular turnable, mounted to the frame 23. Here and preferably the frame 23 comprises a front oblong hole 24 and/or a rear oblong hole 25. The front oblong hole 24 and/or the rear oblong hole 25 may be curved. A bolt of the first actuation lever 19 passes the front oblong hole 24. This bolt actuates the locking element 12 of the front mounting device 6a on actuation of the first actuation lever. This bolt actuates the locking element 12 via its actuation contour 22. A bolt of the second actuation lever 20 passes the rear oblong hole 25. This bolt actuates the locking element 12 of the rear mounting device 6b on actuation of the second actuation lever 20. This bolt actuates the locking element 12 via its actuation contour 22.

The front oblong hole 24 and the rear oblong hole 25 have different inclinations when the front and rear mounting devices 6 are mounted to the profile rail 3. Thereby the frame 23 limits the maximum deviation of the first actuation lever 19 in this situation. For demounting the seat the second actuation lever 20 is actuated. After the actuation lever 20 is actuated the rear mounting device 6b may be demounted. Then the seat can be pivoted. By pivoting the seat the frame 23 is pivoted as well. Thereby the front oblong hole 24 is pivoted also. The inclination of the front oblong hole 24 is increased. Now it allows a larger maximum deviation of the first actuation lever 19. Thus the locking element 12 of the front mounting device 6a can be moved out of the first locking position. The front mounting device 6a is demountable from the profile rail 3.

It is to be understood that the profile rail 6 may be of one part design or may be intersected. It is arranged in a floor F of a vehicle.

1. Vehicle seat mounting arrangement, comprising a profile rail (3) and at least one mounting device (6),
wherein the mounting device (6) comprises a lock mechanism (10) with two bracket elements (11) to be inserted into the profile rail (3) and a locking element (12), which bracket elements (11) may be spread apart from each other into a spreaded state to create a form fit engagement with the profile rail (3), wherein the lock mechanism (10) may be brought into a locked state by driving the locking element (12) into at least one locking position between the bracket elements (11), securing the spreaded state and thereby the form fit engagement with the profile rail (3), and into an unlocked state by driving the locking element (12) out of the locking position, allowing release of the spreaded state and thereby out of the form fit engagement with the profile rail (3),
wherein during inserting the bracket elements (11) an engagement with the profile rail (3) forces the bracket elements (11) at least partly to be spread apart from each other.

2. Vehicle seat mounting arrangement according to claim 1, characterized in that the first and/or second bracket element (11) is/are preloaded towards the other bracket element (11).

3. Vehicle seat mounting arrangement according to claim 1 or 2, characterized in that the bracket elements (11) each comprise a base body (11a) which is made of metal, in particular is made of formed sheet material.

4. Vehicle seat mounting arrangement according to one of the previous claims, characterized in that at least one of the bracket elements (11) comprises a locking contour (11d) which is configured to establish the form fit engagement for locking a release movement of the mounting device (6) directed out of the profile rail (3) when the lock mechanism (10) is in a locked state, preferably, that each bracket element (11) comprises a locking contour (11d) which each is configured to establish the form fit engagement for locking a release movement of the mounting device (6) directed out of the profile rail (3) when the lock mechanism (10) is in a locked state.

5. Vehicle seat mounting arrangement according to one of the previous claims, characterized in that at least one of the bracket elements (11), in particular both bracket elements (11), comprise at least one guiding element (11e), which is part of the form fit engagement for locking a releasing movement directed out of the profile rail (3) when the lock mechanism (10) is in a locked state, preferably, that the guiding element (11e) respectively guiding elements (11e) are of plastic material.

6. Vehicle seat mounting arrangement according to one of the previous claims, characterized in that the profile rail (3) comprises at least one locking contour (3c), preferably two locking contours (3c), each of which at least in part corresponding to an assigned locking contour (11d) of the respective bracket element (11), preferably, that each locking contour (3c) of the profile rail (3) and the assigned locking contour (11d) of the respective bracket element (11) have a complementary shape to each other, more preferably, that the locking contour (3c) of the profile rail (3) is provided by a side wall (3d) of the profile rail (3) or that the locking contours (3c) are provided each by one of the two side walls (3d) of the profile rail (3).

7. Vehicle seat mounting arrangement according to one of the previous claims, characterized in that the profile rail (3) comprises a spreading contour (3a), in particular at the bottom of the profile rail (3), which during inserting of the mounting device (6) into the profile rail (3) forces the bracket elements (11) at least partly to be spread apart from each other, preferably to be spread apart from each other until they reach the form fit engagement with the profile rail (3).

8. Vehicle seat mounting arrangement according to one of the previous claims, characterized in that the bracket elements (11) and/or the locking element (12) comprise an x-locking contour (13), which locks a movement of the mounting device (6) in a x-direction along the longitudinal extension of the profile rail (3), preferably, that the profile rail (3) comprises corresponding x-locking contours (14), which are arranged along the longitudinal extension of the profile rail (3) and allow the locking of a movement in x-direction at several positions along the profile rail (3).

9. Vehicle seat mounting arrangement according to one of the previous claims, characterized in that in the at least one locking position, preferably in the locking positions, the locking element (12) secures the bracket elements (11) in a spreaded state, in which a demounting of the mounting device (6) from the profile rail (3) is prevented, preferably, that the locking element (11) is movable in a first locking position, in which it prevents a demounting of the mounting device (6) from the profile rail (3), in particular additionally allows a movement of the mounting device (6) along the profile rail (3), preferably, that the locking element (12) is movable in a second locking position, in which it prevents a demounting of the mounting device (6) from the profile rail (3) and a movement of the mounting device (6) along the profile rail (3).

10. Vehicle seat mounting arrangement according to one of the previous claims, characterized in that the locking element (12) is transversally, in particular linearly, and/or rotationally movable into and out of the at least one locking position, preferably the locking positions.

11. Riser arrangement for a vehicle seat comprising a profile rail (3) and a riser (9), the riser (9) comprising a front mounting device (6a) and a rear mounting device (6b), both lockable to the profile rail (3), wherein the front mounting device (6a) and the rear mounting device (6b) can interact independently of each other with the profile rail (3),
wherein the front mounting device (6a) and/or the rear mounting device (6b) comprises a lock mechanism (10) with two bracket elements (11) to be inserted into the profile rail (3) and a locking element (10), which bracket elements (11) may be spread apart from each other into a spreaded state to create a form fit engagement with the profile rail (3),
wherein the lock mechanism (10) may be brought into a locked state by driving the locking element (12) into at least one locking position between the bracket elements (11), securing the spreaded state and thereby the form fit engagement with the profile rail (3), and into an unlocked state by driving the locking element (12) out of the locking position, allowing release of the spreaded state and thereby out of the form fit engagement with the profile rail (3).

12. Riser arrangement according to claim 11, characterized in that the front mounting device (6a) and the rear mounting device (6b) can interact independently of each other with the profile rail (3) in that way, that the mounting devices (6) of the riser can be unlocked from the profile rail (3) independently from each other and/or the mounting devices (6) of the riser (9) can be demounted from the profile rail (3) independently from each other.

13. Riser arrangement according to claim 11 or 12, characterized in that the riser (9) comprises an underseat structure (7) to which the front and the rear mounting device (6a, 6b) are mounted, preferably, that the riser (9) allows a pivoting of the underseat structure in relation to the profile rail (3) while one of the mounting devices (6), preferably the front mounting device (6a), is locked to the profile rail (3) and another one of the mounting devices (6), preferably the rear mounting device (6b), is demounted from the profile rail (3).

14. Riser arrangement according to one of the claims 11 to 13, characterized in that one or the mounting devices (6) of the riser (9), preferably the front mounting device (6a), is lockable to the profile rail (3) such that it cannot be moved from the profile rail (3) and cannot be moved along the profile rail (3) and wherein one of the mounting devices (6), preferably the rear mounting device (6b), is lockable to the profile rail (3) such that it cannot be moved from the profile rail (3).

15. Vehicle seat arrangement comprising a vehicle seat (2) and at least one profile rail (3), the seat comprising a padding (2a), a vehicle seat mounting arrangement (1) and/or a riser (9),
wherein the at least one profile rail (3) and the at least one mounting device (6) form a vehicle seat mounting arrangement (5) according to one of the claims 1 to 10 and/or the at least one profile rail (3) and the at least one riser (9) form a riser arrangement (8) according to one of the claims 11 to 14.

16. Vehicle seat arrangement according to claim 15, characterized in that the seat (2) further comprises an actuation lever (19) with which at least one mounting device (6), in particular the front mounting device (6a) or the front mounting devices (6a), is/are lockable and/or unlockable by actuation of the actuation lever (19) such that the mounting device (6) can be removed from the profile rail (3) and can be moved along the profile rail (3).

17. Vehicle seat arrangement according to claim 15 or 16, characterized in that the seat (2) further comprises an second actuation lever (20) with which at least one mounting device (6), in particular the rear mounting device (6b) or the rear mounting devices (6b), is/are lockable and/or unlockable by actuation of the second actuation lever (20) such that the mounting device (6) can be removed from the profile rail (3) and, in particular additionally, can be moved along the profile rail (3), preferably, that the first actuation lever (19) can only be actuated in a position which allows the mounting device (6) to be removed from the profile rail (3) after or simultaneously to an actuation of the second actuation lever (20).
